(19) United States
(12) Patent Application Publication
(10) Pub. No.: US 2005/0167900 A1
(43) Pub. Date: Aug. 4, 2005

(54) Means for strengthening a flat tool used in a machine intended inter alia for packaging industry

(75) Inventor: Jean-Pierre Steiner, Crissier (CH)

Correspondence Address: OSTROLENK FABER GERB & SOFFEN, 1180 AVENUE OF THE AMERICAS, NEW YORK, NY, 100368403, US

(73) Assignee: BOBST S.A.

(21) Appl. No.: 11/044,897

(22) Filed: Jan. 27, 2005

(30) Foreign Application Priority Data
Jan. 30, 2004 (SZ) 00144/04

(51) Int. Cl. B25B 5/14; B25B 1/00

(52) U.S. Cl. 269/36; 269/55; 269/86

(57) ABSTRACT

A means for strengthening a flat tool for use in a machine intended inter alia for the packaging industry. The means comprises at least one mechanism for fixing it to the flat tool and withdrawing it, without addition of any mechanical component or adhesive substance or element.

### BACKGROUND OF THE INVENTION

The invention relates to a means for strengthening a flat tool used in a machine intended inter alia for the packaging industry, more particularly in a waste ejection station of a platen press for making box blanks from sheets of cardboard, paper or e.g. synthetic materials.

A platen press usually comprises a number of stations placed one after the other, including inter alia a feeder for supplying the machine with sheets of cardboard from a stack, a cutting station for cutting the sheets one by one in a given shape in order to produce box blanks, an ejection station for withdrawing undesired waste resulting from cutting, and finally a station for receiving stacks of resulting blanks.

Each sheet is gripped at its front edge by a gripper bar moving on a series of chains which successively bring the sheets into the various stations. The sheets, also called flat elements, processed by the machines usually each comprise a number of blanks representing the developed shapes and surfaces of the finished packaging.

The contours of the blanks are cut out by cutting rules in the platen press whereas the folding lines of the blanks are marked by scoring rules during the same operation. To prevent displacement of the sheet after being cut, the cutting rules are first notched at each join between blanks. Consequently all the blanks are held together by fragile bridges of material or “points of attachment” which remain uncut owing to the notches formed in the cutting rules.

Although the blanks are arranged on the sheet in the most suitable possible manner, waste is inevitably produced as a result of cutting. The waste is made up of the edges of the sheet and the parts separating the blanks in between. These areas constitute the undesirable waste which has to be removed from the sheet in the waste-ejection station.

A station usually comprises a top tool movable in the vertical plane and fitted with ejectors, a perforated ejection board on which the sheets are successively stopped in order to remove the waste, and usually a bottom tool co-operating with the top tool in order to remove waste from the sheet. The top tool is similar in shape to the sheet, i.e. in the form of a perforated board or frame provided with a number of bars bearing ejection needles which detach the waste from the sheet and push it downwards through apertures in the ejection board. Sometimes the top board also comprises pressure plates, consisting e.g. of small cubes of foam designed simply to hold the sheet blanks against the top surface of the ejection board. The bottom tool comprises telescopic ejection needles disposed opposite those on the top board. This arrangement can accurately grip all the waste and withdraw it from the sheet in a single operation via the ejection board. An ejection station of this kind is illustrated and described in greater detail in patent CH 689974.

Sometimes a bottom tool may not be used, in which case the waste is ejected from the sheet by action of the ejectors on the top tool only, which push it downwards. In that case the ejection is called “dynamic”. At high speed, on the other hand, the ejection board is subject to strong vertical pressures since the waste is no longer gripped in order to be removed but has to rest partly on the edges of the openings provided for ejection of the waste in order to make it bend mainly downwards in as to simultaneously break all the attachment points. Unless the sheet is positioned in this way, some attachment points may not be broken so that waste hangs across the apertures in the board and inevitably jams when the sheet is discharged from the ejection station. If therefore the waste is gripped between a top tool and a bottom tool, all the waste can be eliminated from the sheet at very high speed without any jamming.

The invention is applicable in particular to the flat tool, also called the “ejection board”, of a station. The top and bottom tools and the ejection board are usually each disposed and fixed on a supporting frame which can easily be removed like a drawer from the ejection station in the horizontal plane. The ejection board, which is adapted to hold only the sheet blanks while permitting removal of the waste, usually has edges which are not straight but irregular, reproducing the contours of the blanks situated at the periphery of the sheet. Consequently the ejection board cannot be directly fixed by its edges in the supporting frame but needs to be mounted on longitudinal bars adapted to be placed and held in the supporting frame via their ends. The supporting bars usually have a rectangular cross-section, the major edges extending vertically in order to increase the resistance to bending. They are fixed against the bottom surface of the ejection board by screwed angle irons, on the one hand against the sides of the bars and on the other hand in the board. Patent CH 575 294 clearly illustrates this layout in FIGS. 2 and 3.

This embodiment has a number of disadvantages. In order to be fixed, the bars require a number of small separate components (angle irons and screws and nuts), which require relatively lengthy drilling, adjusting and assembly operations. In this embodiment also, an appreciable amount of space on the surface of the ejection board is needed for the fixing angle irons. In view of the large number of screws and bolts needed per injection board, these components are generally recycled together with the fixing angle irons. Since however each ejection board is intended for a specific job, the components have to be recycled by a dismantling operation which only increases the cost of a job. In order to reduce the costs of production and preparation of an injection board, one idea has been to replace the strengthening bars (usually metal) by bars of a different and cheaper material which can be stuck like wood. Since however this material is weaker than metal, the strengthening bars need to be thicker. This over-dimensioning has the disadvantage of occupying more space on the surface of the ejection board and consequently it also becomes more difficult to dispose the bars on the ejection board without blocking any of the apertures provided for ejection of waste. The ends of the supporting bars are usually tapered in shape and machined so that they can engage the fixing system provided on the supporting frame of the station for which the system is intended. When the bars are of wood, they are fragile owing to the tapered profile of their ends and are easily damaged and require special attention during maintenance. Finally, owing to their rapid wear, it has been shown by factory tests that the ejection boards quickly tend to become subject to progressive vibration during prolonged use.

To obviate these disadvantages, another known means is disclosed in document EP 1 348 524, relating to a strengthening bar comprising a number of fixing heads on its top edge for insertion into openings formed in the ejection board. A bar of this kind is mounted on the ejection board by pressing the bar until the fixing heads are properly inserted into the corresponding openings. The fixing heads are each provided with a pair of claws similar in shape to a fish hook, a method of assembly which provides a lasting fixture without any additional part mounted against the sides of the bar.

The disadvantage of this means, however, is that once inserted into the ejection board, the strengthening bar cannot be withdrawn, since this method of fixing is permanent, final and for use once only. Each new shaping operation of a sheet in a platen press requires specific tools for the various stations, depending directly on the required shape of the blanks. In the case of small series, the cost of making the packages is increased by the short useful life of the specific flat tools, which cannot be exchanged even for series which are only slightly different. By way of comparison, the value of a set of strengthening bars for a flat tool accounts for about 25% of the selling price of the ejection board. The cost of the strengthening bars is therefore appreciable in proportion to the cost of the flat tool. As can be seen, therefore, it would be desirable to recycle the bars in order to re-use them on other flat tools.

Another disadvantage of the means is that it is the result of a uniform standard production process without any possibility of adaptation outside the initial master pattern for which it was designed. It is therefore impossible to use the same means for flat tools having dimensions different from those originally provided. It is not unusual to find pools of machines made up of a number of presses from different manufacturers and using specific non-standard tools.

Another disadvantage of this means is that an additional tool such as a hammer or mallet has to be used for properly driving the strengthening bars into the flat tool. Owing to the shape of the claws, which have projecting parts for inserting in the sides of the openings in the ejection board, some force has to be applied in order properly to press the top edge of the bar against the surface of the flat tool. The force increases with the number of fixing heads and depends directly on the machining tolerance between the overall width of the claws and the width of the opening into which they are to be inserted. Also owing to the cutting effect of the narrow edge of the strengthening means, it is difficult for an operator to position a number of bars bare-handed on a single ejection board. Use of a striking tool will be an obvious nuisance which it is desired to reduce, since the environment is already noisy owing to the constant operation of the surrounding machines.

### SUMMARY OF THE INVENTION

The object of the invention is to provide a means which can strengthen a flat tool in a machine for producing packaging, more particularly in an ejection station of a platen press, without any of the disadvantages. The means must also be of use for supporting and fixing the flat tool. To this end, the object according to the invention must be recoverable for subsequent use on other flat tools, and accordingly the tool needs to be easily and quickly fitted and dismantled from each flat tool. The process of securing on the tools must not be dependent on any additional component and should not involve use of any adhesive substance or any other component capable of producing the same effect. Another object of the invention is to provide a means which can vary in length in adaptation to any conventional cutting tool. Finally the means in question must be cheap to produce compared with the selling price of the flat tool for which it is used and relative to its service life, i.e. must be usable without limit until a constituent component thereof breaks.

These objects are achieved by the invention, which relates to a means for strengthening a flat tool according to claim 1.

Other features and advantages of the present invention will become apparent from the following description of the invention which refers to the accompanying drawings.

### BRIEF DESCRIPTION OF THE DRAWINGS

The invention will be more clearly understood from an embodiment taken by way of non-limitative example and illustrated by the accompanying drawings in which:

FIGS. 1a and 1b are views in elevation respectively of the front and central part and of the rear part of the object according to the invention, illustrated in an “open” position on a flat tool shown in section;

FIG. 2 is a view in elevation of the front part of the object according to the invention, illustrated in a “closed position”;

FIG. 3 is a left view of FIG. 2, and

FIG. 4 is a top view of FIG. 2.

### DETAILED DESCRIPTION OF PREFERRED EMBODIMENTS OF THE INVENTION

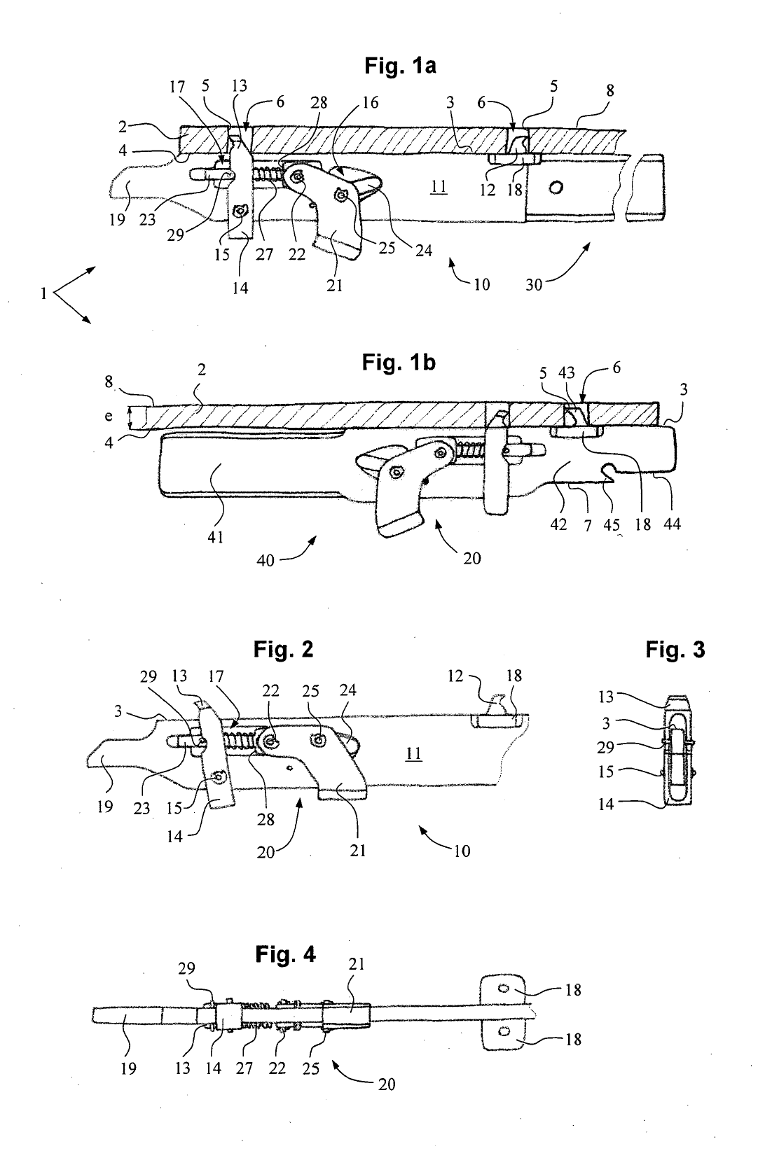

FIGS. 1a and 1b are views in elevation illustrating the means 1 according to the invention in an “open” position on a flat tool 2 shown in section. Since the means 1 is elongate in shape similar to a bar, it is shown in two portions in FIGS. 1a and 1b respectively. FIG. 1a shows the front part 10 of the means 1 and the central part 30 thereof partly in section, whereas FIG. 1b shows the rear part 40 for engaging in the central part 30. The general shape of the means 1 is preferably that of a straight bar having a narrow cross-section and disposed with its top edge 3 against the bottom surface 4 of the flat tool 2. The tool can typically be an ejection board of a platen press (not shown).

In a preferred embodiment, the front part 10 inter alia comprises a body 11 provided with a mechanism 20 for fixing the means 1 on the flat tool 2 by moving from an “open” position to a “closed” position and conversely for withdrawing the means 1 from the flat tool 2.

The means 1 is secured by at least one fixed lug 12 and at least one moving lug 13, both secured to the means 1 and each adapted to engage a side 5 of an opening 6 formed for this purpose in the flat tool 2. Each lug has a cutting or pointed end for easy insertion e.g. into wood. In the preferred embodiment, the fixed lug 12 faces the rear and comprises a protuberance on the body 11 situated at the rear end thereof against the top edge 3. The movable lug 13 faces the front so as to point in the opposite direction to the fixed lug 12. The movable lug 13 can also move in the longitudinal direction and constitutes the top part of a stirrup 14 mounted for swinging around a shaft 15 through the body 11 of the means 1 as illustrated inter alia in FIG. 3.

The movable lug 13 is moved longitudinally by action of the mechanism 20 which, when in the open position, brings the stirrup 14 into a preferably vertical position as illustrated in FIG. 1a, whereas in the closed position as illustrated in FIG. 2 the mechanism 20 forces the lug 13 forwards around its axis of rotation 15 so that the lug 13 can engage the flat tool 2 by entering the side 5 of the corresponding opening 6. For this purpose the closing and opening mechanism 20 comprises a lever in the form of a bent handle 21 connected at one end to a rod 23 by a first joint 22 and connected by its shank to the end of a bar 24 by a second joint 25. As shown more clearly in FIG. 1a, the bar 24 also serves as a lever and its opposite end bears on the bottom of an aperture 16 formed in the body 11 of the means 1. The rod 23 extends through the stirrup 14 and slides longitudinally in a groove 17 made for this purpose in the body 11 of the means 1. Between the first joint 22 and the stirrup 14, the rod 23 has a section surrounded by a resilient means 27 illustrated by a compression spring in FIGS. 1a, 2 and 4. The resilient means or compression spring bears at the rear against a shoulder 28 of the rod 23 whereas the front rests against the stirrup 14 and pushes it until it abuts a detent pin 29 transversely fixed relative to the rod 23. The movable lug 13 is thus pressed both by action of the bent handle 21 when closed and by action of the resilient means 27.

As illustrated more particularly in FIG. 4, in order to improve and stabilize the means 1 when placed upright on its top edge 3, at least one rib 18 is mounted on the edge in order to form a small additional bearing surface against the bottom surface 4 of the flat tool 2.

At least one end 19 of the means 1 is profiled so that it can be gripped by the position-finding and clamping device (not shown but provided in the platen press for holding the flat tool 2 properly in the machine).

FIG. 1b illustrates the rear part 40 of the means 1 according to the invention. The rear part, which can but need not be detached from the means 1, is movable in the longitudinal direction relative to the front part 10, preferably by sliding. To this end the part comprises inter alia a sliding portion 41 and a tail 42. The sliding portion 41 slides along the central part 30 of the means 1. For this purpose, in the preferred embodiment, the central part 30 is a tubular part with inner dimensions slightly greater than the outer dimensions of the sliding portion 41. When therefore the two parts slide relative to one another, the length of the means 1 can vary as needed by the user within a range corresponding to the length of the sliding travel.

The tail 42 has a lug 43 facing the front and similar or identical in shape with the fixed lug 12 described previously. The lug 43 is preferably fixed and serves the same purpose as the fixed lug 12. Advantageously the tail also has a rib 18 for stabilizing the means 1. In the preferred embodiment as illustrated in FIG. 1b, the tail likewise has a fixing mechanism 20 identical with that in the front part 10 as previously described.

The rear part 40 of the means according to the invention comprises a stop 45 against which a locking means belonging to the packaging machine can bear and push the rear part 40 in the longitudinal direction. To this end, a cross-bar of the machine slides on a flat part 44 at the end of the tail 42, on the bottom edge 7 of the means 1. The bar (not shown since it forms part of a fixing device outside the invention) is the clamping means for holding the flat tool 2 in the machine. When the cross-bar comes in contact against the stop 45 on the edge 7 at the front of the flat part 44, therefore, it can push the tail 42 of the means 1 forward so that the lug 43 is planted in the side 5 of the corresponding opening 6 and thus entrains the entire flat tool 2 in the same direction until it can be gripped in the machine via the end 19.

The means 1 according to the invention has the advantage of being simple, quick and reliable in use. It can be positioned and fixed simply by inserting the lugs 12, 13 of the front part 10 into the corresponding openings 6 in the flat tool 2, adjusting the length of the means 1 and sliding the rear part 40 along the central part 30 until the lug 43 of the tail 42 also slides into an opening 6, pressing the top edge 3 of the means 1 against the bottom surface 4 of the flat tool, and lowering the bent handle 21 in order to close the fixing mechanism 20. The means can be equally easily withdrawn from the flat tool by the same operations in the reverse sequence. Note in this connection that the means 1 can be positioned and withdrawn without any additional tool or other mechanical part.

Owing to the simplicity of operation and use thereof, the means can be roughly constructed without regard to appearance. For example the joints 22, 25, the shaft 15 and the detent pin 29 can be in the form of simple resilient pins. The front part 10 and rear part 40 can advantageously be cut out by machining with a laser, like the aperture 16 and the groove 17 inter alia. The tubular shape of the central part 30 can be obtained by bending and welding a plate provided for the purpose. The front and central parts, like the ribs 18, can likewise be assembled simply by welding. As can be seen, therefore, the cost of constructing a strengthening means of this kind can be reduced to the minimum without adversely affecting the required stability.

Note that the openings 6 are preferably square or rectangular and their sides are advantageously vertical but can slope slightly or have a particular profile. The openings 6 can be very easily machined by a laser, particularly when the flat tools are made of wood as is generally the case. This method of machining gives a neat precise cut while keeping within tolerances which are more than sufficient for an application of this kind. Owing also to the action of the resilient means 27 of the fixing mechanism, the means 1 is firmly fixed without clearance in the flat tool 2. Advantageously therefore the openings 6 do not require any tight tolerances, which advantageously contributes to reducing the cost of production.

Note that the means 1 is clamped by pressing the rear lug 12 and the front lug 13 into openings 6 by opposing forces directed towards the exterior of the flat tool 2. The same clamping effect, however, can be obtained by opposite forces directed towards the interior of the tool 2.

As illustrated in FIGS. 1a and 1b, as will also be noted, once the means 1 has been properly fixed to the flat tool, the lugs 12, 13 and 43 are advantageously all embedded in the thickness e of the flat tool 2 and consequently do not project from the top surface 8 of the tool. This preferred arrangement avoids any projecting parts on the top surface 8 of the flat tool and thus eliminates any risk of moving parts of the machine catching in the platen press, such as the gripper bars moving along the upper surface. This arrangement also avoids any risk of injury to the machine operator who has to use these flat tools, particularly in operations such as changing the tools during preparation of the machine.

Although the mechanism 20 of the front part 10 is preferably reproduced in the rear part 40 of the means 1, another alternative is to dispose the mechanism only in the front part or in the rear part of the means 1 or at another place along the means 1.

In another variant it may be advantageous to provide a retaining means for stopping the central and rear parts sliding relative to one another in order to limit the length of the extension travel of the means 1 and also prevent any premature separation of the two parts during use thereof.

Finally the constituent elements of the means 1 are preferably made of metal such as steel or aluminum, though this is not essential. Also, although it could be different, the general shape of the means 1 is rectangular in section and its thickness depends mainly on the strength of the material used, the maximum possible length of the means 1, and the force which must be absorbed by the flat tool 2 in order at least to withstand the strongest stresses for which it has been dimensioned. Finally it is also possible, while retaining sufficient strength, to reduce the weight of the means according to the invention by forming a number of openings in those portions or parts 10, 30 and 40 which are without any particular functions.

Numerous improvements can be made to the means according to the invention within the scope of the claims.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1. A device for strengthening a tool, the tool having at most a first thickness at first locations along a length dimension of the tool, and the tool having a plurality of openings toward the device at the first locations, wherein each opening in the tool has a side which defines the opening;
the device comprising at least one fixed lug fixed on the device, at least one movable lug on the device and movable with respect to the fixed lug, the movable lug also extending in the opposite direction along the length dimension from the fixed lug;
a mechanism driving the movable lug for fixing the device on the tool via the lugs and for enabling withdrawal of the device from the tool, wherein each lug is adapted to engage the side of a respective one of the openings for receiving the lug in the tool.

2. A device according to claim 1, wherein the device has an elongate straight shape.

3. A device according to claim 2, wherein the device has a narrow profile defining a top edge and the edge makes contact with a bottom surface of the tool.

4. A device according to claim 1, wherein the fixed lug and the movable lug are each of a length into the respective lug openings in the tool such that the fixed and movable lugs are embedded in the first thickness of the tool.

5. A device according to claim 1, wherein the device is of variable length along the length direction.

6. A device according to claim 5, wherein the device comprises at least a front part and a rear part movable longitudinally relative to one another.

7. A device according to claim 6, wherein the rear part slides along a central part and the central part is integral with the front part.

8. A device according to claim 6, wherein the rear part comprises a stop against which a clamping device may bear to push the rear part of the device in a longitudinal direction to insert at least one of the lugs on the rear part into the side of the corresponding opening in the tool.

9. A device according to claim 6, wherein the mechanism is disposed in at least one of the front part and the rear part.

10. A device according to claim 9, wherein the mechanism is operable to drive the movable lug in the longitudinal direction, and the mechanism has a closed condition which pushes the movable lug into the side of the opening therefor in the tool and has an open condition which withdraws the movable lug from the side of the opening; and a resilient device operating against the withdrawal of the movable lug.

11. A device according to claim 3, further comprising at least one stabilizing rib mounted against the device so that it can lean against a bottom surface of the tool.

12. A device according to claim 4, wherein the device comprises at least a front part and a rear part movable longitudinally relative to one another.

13. A device according to claim 9, further comprising at least one stabilizing rib mounted against the device so that it can lean against a bottom surface of the tool.

14. In combination, the device of claim 1, and a tool to be used in combination with the device, the tool being a flat tool having the first thickness and having a side toward the device with openings therein at the locations and to receive the lugs.
